(19) United States
(12) Patent Application Publication
(10) Pub. No.: US 2002/0078510 A1
(43) Pub. Date: Jun. 27, 2002

(54) Methods and devices for cleaning soiled fabrics

(76) Inventor: Clarence C. Lee, Atlanta, GA (US)

Correspondence Address: JOHN S. PRATT, KILPATRICK STOCKTON LLP, 1100 PEACHTREE, SUITE 2800, ATLANTA, GA, 30309, US

(21) Appl. No.: 09/748,713

(22) Filed: Dec. 21, 2000

(51) Int. Cl. C11D 17/00

(52) U.S. Cl. 8/137; 510/276; 510/305; 510/425

(57) ABSTRACT

The present invention is directed to devices and methods of use thereof for cleaning fabric, cloth or apparel. More particularly, the present invention relates to methods of cleaning using small portable devices for cleaning that dissolve, dissociate or digest stains from fabric or cloth. The devices comprise at least one chamber. The cleaning solution flows through the fabric and removes the stain or soiling material.

### FIELD OF THE INVENTION

The present invention relates to devices and methods of use thereof for cleaning a piece of fabric, cloth or apparel. More particularly, the present invention relates to methods of cleaning using small portable devices for cleaning that dissolve, dissociate or digest stains from fabric or cloth.

### BACKGROUND OF THE INVENTION

Soiled fabric or cloth is usually cleaned by immersion in a fluid cleaning solution inside a container with or without mechanical agitation to remove the undesirable substance or stains. The fabric or cloth is then removed from the container. Alternatively, the fluid cleaning solution is drained from the container prior to removing the article from the container. Either way, the entire article must be dried or allowed to air dry.

There are several disadvantages to this traditional method of cleaning or removing a substance or stain from soiled fabric or cloth. Specifically, there is the need to dispense the fluid cleaning solution from a storage container or pipelines into the cleaning container, there is often the need for vapor or mist control during the immersion process, and there is the immediate need to safely and appropriately dispose of the fluid. Additionally, the entire piece of soiled fabric must be immersed in the fluid. The entire process is generally time-consuming and requires the use of large equipment. In addition, because the usual cleaning equipment is not accessible at the time of soiling the clothes or fabric, the stains are often more difficult or even impossible to remove at the later time when the cleaning equipment is accessible. Furthermore, the necessity of washing the entire article to remove a stain from a very small portion of the article often results in more frequent cleaning of the article which, in turn, causes additional wear and tear on the article.

The present invention solves many of the problems of traditional cleaning devices and methods. The portability of the device of the present invention allows for immediate use at the time of soiling the clothing or fabric. Additionally, the device of the present invention enables the user to clean only the stained or soiled portion of fabric. Furthermore, the cleaning process is much more rapid and user-friendly than conventional methods.

### SUMMARY OF THE INVENTION

The present invention comprises devices and methods of use thereof for cleaning stains from fabric or cloth. The devices are portable and easy to use. A preferred embodiment of the present invention comprises at least one chamber, and preferably comprises at least one chamber that functions as a fluid source, a cleaning solution, and a fluid receptacle. Fluid sources include containers made of plastic, metal, composite materials, glass, ceramic, polymers, bio-polymeric containers and combinations thereof. Cleaning solutions include solvents, surfactants, water, hydrolytic enzymes, and bleaches, as well as various combinations of these. Fluid receptacles include containers made of materials, such as, plastic, metals, composite materials, glass, ceramic, polymers and bio-polymers and combinations thereof.

The devices are directly applied to the stained fabric. One method comprises placing the fabric between a chamber, the fluid source, which contains or can contain the fluid cleaning solution, and a second chamber, the fluid receptacle. When the cleaning solution is transferred from the fluid source to the fluid receptacle, the stained fabric is in the path of the flow of the cleaning fluid. The undesirable substance or stain is thereby removed from the fabric by the cleaning solution.

Accordingly, an object of the present invention is to provide devices and methods for cleaning soiled or stained fabric or cloth.

Another object of the invention is to provide portable devices and methods for cleaning soiled fabric.

Still another object of the present invention is to provide devices and methods for cleaning stained fabric that are easy to use.

Yet another object of the present invention is to provide cleaning devices and methods that allow for a stained or soiled article of fabric or cloth to be cleaned without immersing the entire article in fluid.

Another object of the invention is to provide devices and methods for cleaning only a portion of the article of fabric or cloth, namely the portion containing the stain.

Still another object of the invention is to provide devices and methods for removing a stain from an article of fabric or cloth.

Other objects, features and advantages of the present invention will become apparent from the following detailed description.

### BRIEF DESCRIPTION OF THE FIGURES

FIG. 1—A perspective view of an embodiment of the portable cleaning device of the present invention.

FIG. 2—A side view of an embodiment of the portable cleaning device of the present invention with a piece of stained fabric.

FIG. 3—A side view of an embodiment of the portable cleaning device of the present invention in use. The arrows indicate the flow of the fluid cleaning solution within the device.

FIG. 4—A cross-section view of an embodiment of the portable cleaning device of the present invention in use. The arrows indicate the flow of the fluid cleaning solution within the device.

FIG. 5—A cross-section view of an embodiment of the portable cleaning device of the present invention having a flat member as a second piece.

FIG. 6—A cross-section view of an embodiment of the portable cleaning device of the present invention having a shallow member as a second piece.

FIG. 7—A top view of a fluid source of an embodiment of the present invention having a foil covering.

FIG. 8—A partial cross-section of an embodiment of the present invention having a fluid source and a fluid receptacle with threads.

FIG. 9—A partial cross-section of an embodiment of the present invention having a fluid source and a fluid receptacle with a snapping mechanism.

FIG. 10—A cross-section of an embodiment of the present invention in which the fluid source and the fluid receptacle have a snapping mechanism and in which the fluid receptacle has an outwardly extending lip.

### DETAILED DESCRIPTION OF THE INVENTION

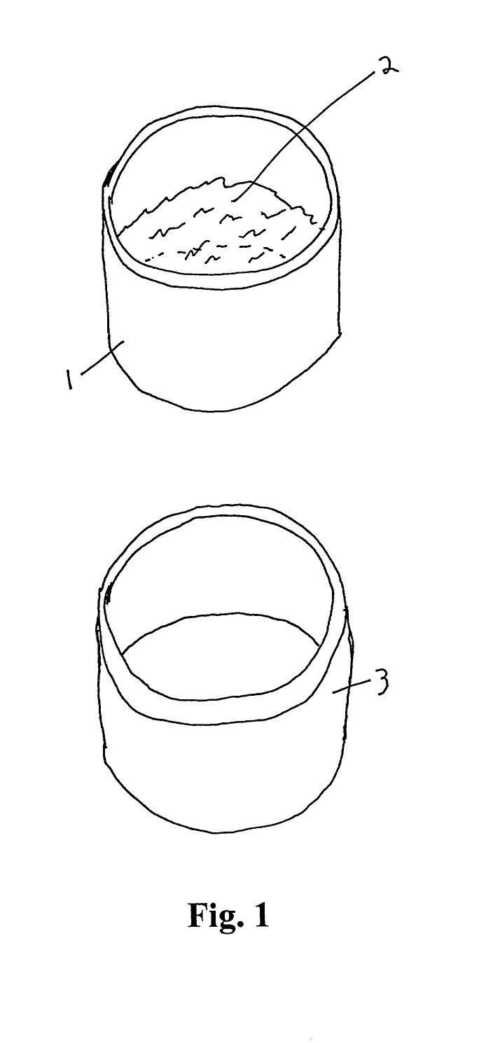

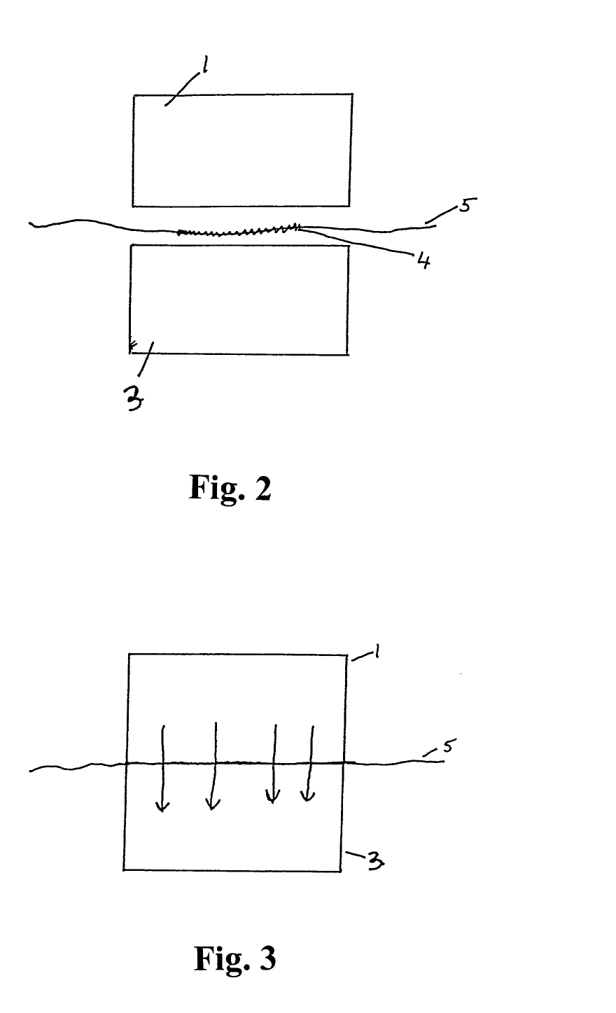

An embodiment of the present invention is shown in FIGS. 1, 2 and 3 and is comprised of chambers, including a fluid source 1 and a fluid receptacle 3, and a fluid cleaning solution 2. The fluid cleaning solution 2 flows from the fluid source 1 to the fluid receptacle 3 during the process of removing the undesirable substance or stain 4 from the fabric 5. Because only the localized area having the stain is treated, the cleaning device is very efficient. Only a minimum amount of fluid cleaning solution 2 is required, the cleaning process is very rapid, and the dampened spot air dries quickly. A most preferred embodiment comprises a device having a chamber comprising a flat surface that is an outlet for the cleaning solution. Preferably, the flat outlet of the chamber has a minimum area of 0.03 cm².

An alternative embodiment of the present invention comprises devices and methods that comprise at least one chamber. The at least one chamber can function as the fluid source chamber or as the fluid receptacle chamber. In preferred methods and devices where the chamber functions as the fluid source chamber and contains the cleaning solution or is capable of holding the cleaning solution provided separately, an absorbant member, or absorbant material, is used to contain the cleaning solution after it flows through the fabric. For example, an absorbent-containing absorbing material is placed on one surface of the soiled fabric and the chamber containing cleaning solution is placed on the opposite surface of the fabric, so that the opening in the chamber is opposed to the absorbant material. The cleaning solution is released from the chamber, flows through the stained fabric and into the absorbant material. Additionally, the fluid may be allowed to flow freely without the use of the absorbant material. For example, the soiled fabric is held adjacent to the opening in the chamber containing cleaning solution and the cleaning solution is released, flows through the fabric and into a sink or other fixture.

Any fabrics or clothing can be treated using the devices and methods of the present invention. Such fabrics include, but are not limited to natural and synthetic materials, woven materials, nonwoven materials, felt, non-porous materials, blends and combinations. Synthetic materials include, synthetic polymers, including but not limited to, acetates, acrylics, acrylamides, nylon, rayon, polyester, PVC, Tyvac, blends and combinations. Natural materials include, natural animal and plant polymers, including but not limited to, silk, cotton, wool, linen, leather, blends and combinations.

Fluid sources 1 of this embodiment include containers made of plastics, metals, alloys, composite-materials, glass, ceramics, polymers and bio-polymers and combinations of them. The types of polymers that can be used to make the fluid sources 1 include but are not limited to natural polymers, synthetic polymers and genetically engineered polymers. Natural polymers include, but are not limited to, dextrans, cellulose, starches, alginate, cotton, chemically modified natural polymers, blends and combinations. Synthetic materials include, but are not limited to, synthetic polymers, including but not limited to, acetates, acrylics, acrylamides, nylon, rayon, polyester, PVC, Tyvac, blends and combinations.

The fluid sources 1 can also be constructed of various combinations or blends of these materials or of other materials that would be viewed as appropriate for this type of container by one skilled in the art. The configurations of the fluid sources 1 include round, triangular, square, rectangular, pentagon, hexagon, and other regular and irregular shapes. The dimensions of fluid sources 1 vary to contain desirable amount of the fluid cleaning solutions and to enable the cleaning of a variety of stain sizes and shapes.

The cleaning solution 2 of the present invention has the ability to dissolve, dissociate or hydrolyze organic or inorganic stains. Cleaning solutions include but are not limited to, solvents, surfactants, detergents, water, hydrolytic enzymes, aqueous enzyme solutions, reducing agents, bleaches, fabric brighteners, blends or combinations thereof. Solvents include common industrial solvents and compounds that dissolve organic matters, particularly organic solvents. Examples are alcohols, including ethanol and isopropyl alcohol, acetone, ethers, benzene, toluene, dimethyl sulfoxide, benzene, THF (tetrahydrofuran), PERT, petroleum spirit, blends and combinations and other solvents known in the art.

Surfactants include biosurfactants, synthetic surfactants, copolymers and combinations of them. Typical surfactants include cationic, anionic and nonionic emulsifiers and detergents, and any chemical with one or more hydrophilic end(s) and a hydrophobic backbone. As used herein, emulsifier means “a surface-acting agent (as a soap) for promoting the formation and stabilization of an emulsion”. As used herein, detergent means “anything that has a strong cleansing power, as soap, a chemical substance, or a synthetic preparation having cleansing properties”. Examples of nonionic emulsifiers and detergents are Triton X-100, polysorbates (Span 20 & Tween 20, Tween 80, etc). Examples of ionic emulsifiers and detergents are sodium lauryl sulfate, alkyl benzene sulfonates, sodium stearate and benzalkonium chloride. Examples of hydrolytic enzymes include proteolytic enzymes, amylases, proteinases, aminopeptidases, carboxypeptidases, lipases, DNase, RNase and enzymes that hydrolyze polysaccharides and blends and combinations. Examples of bleaches include oxidizing bleaches, such as hydrogen peroxide, chlorine and chlorine-releasing substances, reducing bleaches, such as sulfur dioxide and optical bleaches such 4-Methoxy-N-methyl-1,8-naphthalimide, and 7-(2H-Napthol[1,2-d]triazol-2-yl)-3-phenylcoumarin. Bleaches also comprise chlorinated coupounds, peroxides, reducing agents, color brighteners, blends and combinations.

Chambers as fluid receptacles 3 of this embodiment shown in FIGS. 1, 2 and 3 include containers made of plastics, metals, composite-materials, glass, ceramics, polymers, bio-polymers, blends, and combinations or mixtures of these materials. The types of polymers that can be used to make the fluid receptacles 3 can, for example, include natural polymers, synthetic polymers and genetically engineered polymers. The fluid receptacles 3 can also be constructed of various combinations or blends of these materials or of other materials that would be viewed as appropriate for this type of container by one skilled in the art.

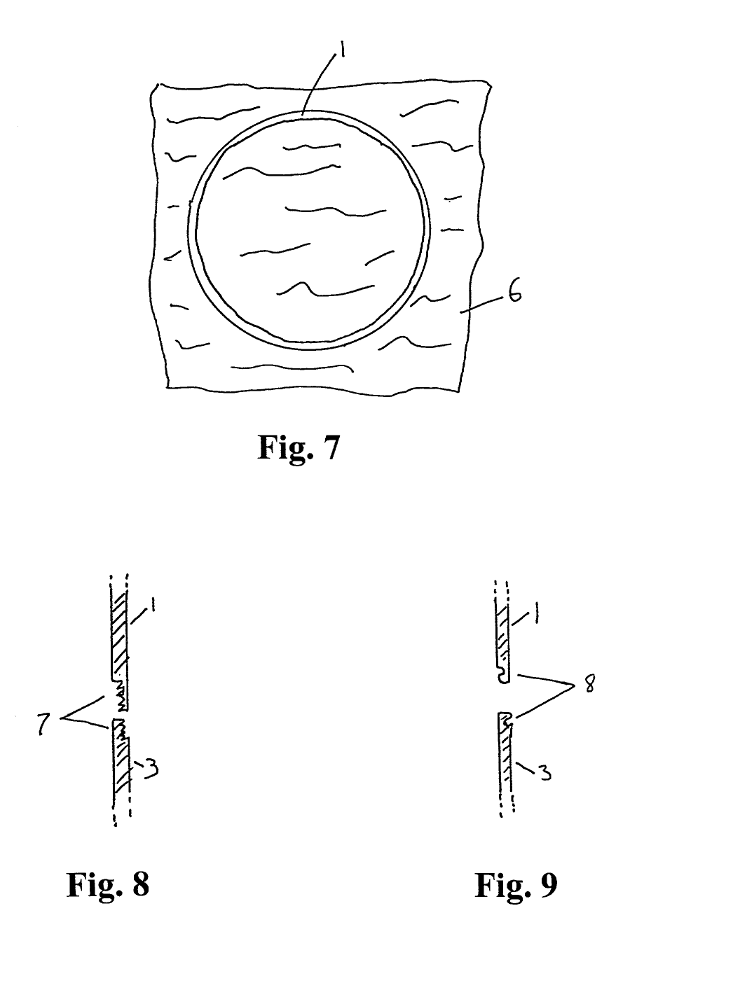

The fluid sources 1 and receptacles 3 of this embodiment are easy to produce by extruding, molding, stamping or casting the desired shape. In an embodiment in which the fluid source 1 and receptacle 3 are two separate members and in which the cleaning solution 2 is provided as a liquid, a pure liquid, a mixture of two or more liquids, or a solution is prepared as the appropriate fluid cleaning solution 2. Then, the source 1 is filled with the fluid and the opening or openings are sealed with a fluid barrier such as foil 6, see FIG. 7, or capped with a cover.

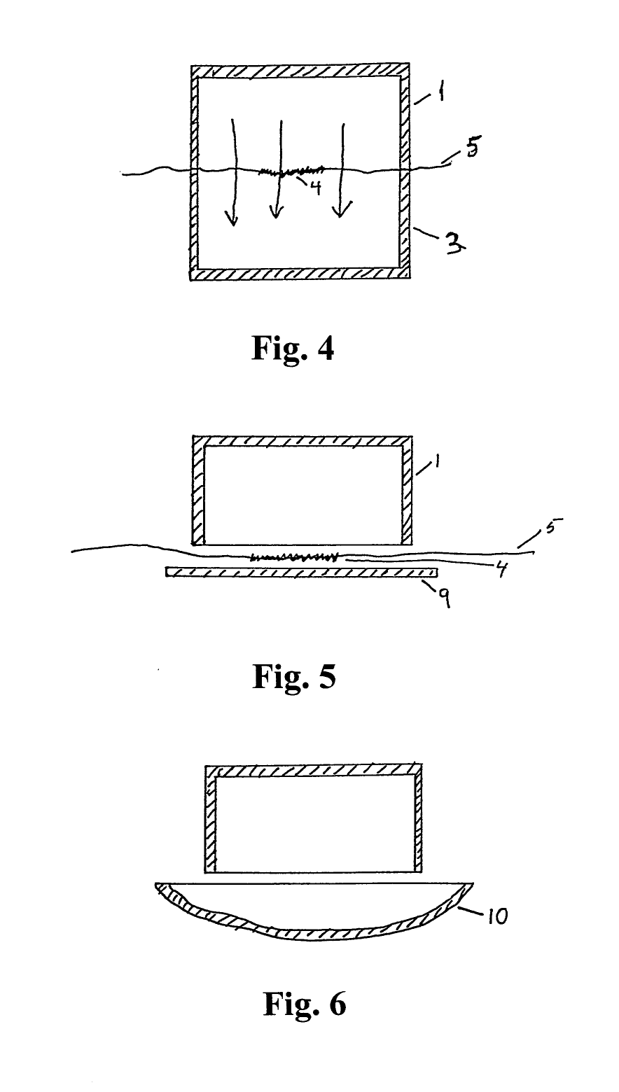

In using the device shown in FIGS. 1, 2 and 3, the fluid receptacle 3 is placed on one side of the stained article. One method comprises placing the article above the fluid receptacle 3. The fluid source 1 is opened to allow the fluid cleaning solution 2 to flow out of fluid source 1, preferably through the opening or openings, onto the stained article using such methods as squirting, squeezing or by gravitational force. While the fluid cleaning solution 2 flows from the source 1 through the stained article to the receptacle 3, by gravitational force, capillary effects, and/or other mechanisms, the stain is removed from the fabric by the fluid cleaning solution 2. FIG. 4 shows a cross-section view of a device of the present invention and illustrates a method of cleaning fabric. The arrows indicate the movement of the fluid cleaning solution 2 from liquid source 1, through the fabric 5, and into fluid receptacle 3.

One advantage of the present invention is that there is no need to use traditional cleaning equipment to wash the fabric. Stains that might otherwise dry or cake onto the fabric if cleaning had to be delayed until the larger traditional cleaning equipment became available, can be cleaned immediately. After the completion of the process, both the empty fluid source 1 and the fluid-filled receptacle 3 can be stored conveniently for future appropriate disposal.

In another embodiment, the device is provided as a fluid source 1 and a fluid receptacle 3. The liquid cleaning solution may be provided in a separate container. In this embodiment, the user adds water or some other available cleaning solution to the fluid source 1 at the time of use. The stained portion article is placed above the fluid receptacle 3. Once the water or other liquid cleaning solution has been placed into the fluid source1, the fluid source 1 is inverted over the stain to be cleaned. While the water or fluid cleaning solution flows gradually from the source 1 through the stained article to the receptacle 3, by gravitational force, capillary effects, and/or other mechanisms, the stain is removed from the fabric by the water or fluid cleaning solution. This embodiment has the advantage of being lighter, and is therefore more portable and convenient.

In another embodiment, the cleaning solution is supplied in dry form in fluid source 1. In this embodiment, the user adds water to the cleaning solution in dry form just prior to use. Once the cleaning solution is in solution, the device is used to remove the stain as described above. This embodiment has the advantage of being lighter, and is therefore more portable and convenient.

In other embodiments, the cleaning solution is supplied in separate packets or pouches. At the time of use, these cleaning solutions are transferred from the packet or pouch to the fluid source 1. The device is then used as described herein to clean the soiled fabric. This embodiment allows for multiple cleaning solutions to be used with the same fluid source 1 and fluid receptacle 3.

Other embodiments of the present invention, such as those that rely on gravitational force to move the cleaning solution from the fluid source 1 through the fabric to the fluid receptacle 3, allow for the cleaning solution to be passed through the stained portion of the fabric multiple times. Once the fluid flows from the fluid source 1 through the fabric to the fluid receptacle 3, the fluid can be returned to fluid source 1 to repeat the cycle multiple times. In another embodiment, once the cleaning solution has initially passed from fluid source 1 through the fabric into the fluid receptacle 3, the entire device, comprising source, fabric and receptacle may be simply inverted. The cleaning solution is then pulled through the stained fabric again by the force of gravity into the fluid source 1. In effect, the fluid receptacle 3 becomes the “source” and the fluid source 1 becomes the “receptacle.” This method can be used in any embodiment in which the fluid source 1 is constructed such that it can act as a fluid receptacle 3.

Additionally, many embodiments of the present invention allow for the cleaning process to be enhanced by manual agitation. Once the soiled fabric is secured between the fluid source 1 and the fluid receptacle 3 and the fluid cleaning solution is flowing through the soiled fabric, the source-fabric-receptacle complex can be shaken as a unit. Such agitation aids in the removal of the stain from the fabric. Whether agitation is desirable and the intensity of the agitation if it is desired depends upon the cleaning solution used. Agitation is less desirable with cleaning solutions that tend to foam upon agitation. Preferably, this method is used in embodiments in which the fluid cleaning solution will not be spilled during agitation. Such embodiments are generally those in which there is a tight fit between the fluid source 1 and the fluid receptacle 3 even with the cloth between the two chambers.

In another embodiment, the device of the present invention can be used more than once. In this embodiment, the fluid source 1 and the fluid receptacle 3 fit together when the soiled fabric or cloth is positioned between them, as described above. In addition, the fluid source 1 and fluid receptacle 3 fit tightly when there is no fabric or cloth between them such that the cleaning fluid is securely held within the source-receptacle unit. For example, as shown in FIG. 8, the lips of a cylindrical fluid source 1 and a cylindrical fluid receptacle 3 can be constructed with threads 7 such that the two can be securely fastened together by screwing one into the other. Alternatively, as shown in FIG. 9, the fluid source 1 and fluid receptacle 3 can be fashioned such that each contains a snapping mechanism 8 that secure the source 1 and receptacle 3 together to hold the fluid cleaning solution securely inside the device between uses. The present invention comprises the joining of the two members by any method known to those skilled in the art. When the user wishes to use the device again, he or she separates the fluid source 1 and the fluid receptacle 3 and uses the device to clean the soiled fabric as described herein.

In alternative embodiments of the present invention, one or more components of the device comprise a piercing element, such as prongs or needles, that pierce the fabric held between the components. The piercing element holds the fabric and also facilitates the movement of the cleaning solution from one component to the second component of the device. Alternatively, the piercing element is a separate component that can be used to pretreat the fabric prior to insertion between the components for fluid flow. The method comprises repeatedly piercing the fabric in the stain area to allow for ease of fluid flow through the area. The piercing element is made of many sharp needle-like projections and can be made from any material that provides enough strength to at least pierce or dimple fabric. The projections can be made hollow so as to transmit fluid to the interior of the fabric, or at least past an outer surface of the fabric.

In other embodiments of the present invention, the device of the present invention utilizes the cleaning advantages of heated cleaning solutions. For example, the cleaning solution is heatable, for example, by heating the cleaning solution in a microwave while the cleaning solution is still contained in the fluid source 1. This allows the user to increase cleaning efficiency by using a hot cleaning solution. The fluid source 1 of embodiments that are heatable in a microwave are constructed of microwavable material and are preferably constructed of a material that is a poor heat conductor. Alternatively, in an embodiment providing the cleaning solution in a dry form, hot water can be added to the dry cleaning solution prior to use.

Other embodiments employing the principles of the invention will be apparent to those skilled in the art. For example, in an alternative embodiment, the fluid source is provided as a sealed packet. In use, the packet fluid source is opened and the fluid cleaning solution is poured or squirted out of the fluid source, through the stained fabric and into the fluid receptacle 3. The packet can be provided with various modifications, such as a collar or nozzle, to aid in the accuracy of the delivery of the fluid cleaning solution through the stained fabric and into the fluid receptacle 3.

In another embodiment of the present invention, the same container can act as both the fluid source 1 and the fluid receptacle. In this embodiment, shown in FIGS. 5 and 6, the fluid source 1 is paired with a flat second piece 9 or a relatively shallow second piece 10. The flat piece is placed on one side of the fabric at the area to be cleaned. The fluid source 1 is then placed on the other side of the fabric and pressed against the flat piece through the fabric. The cleaning solution is allowed to contact the soiled fabric, with or without agitation, until the stain is removed. When the cleaning is finished, the device is inverted so that the cleaning solution is held in the fluid source 1. The fluid source 1 can then be resealed with the cleaning solution inside. Instead of a flat second piece, a shallow second piece can be used. See FIG. 6. The shallow second piece is used in the same manner as the flat second piece but allows the cleaning solution to flow around both sides of the soiled fabric.

In another embodiment, this second piece is connected to the fluid source 1 by a hinge. In this embodiment, the stained piece of fabric could be folded at or near the location of the stain thereby allowing the fluid source 1 and the second piece to fit over the stain.

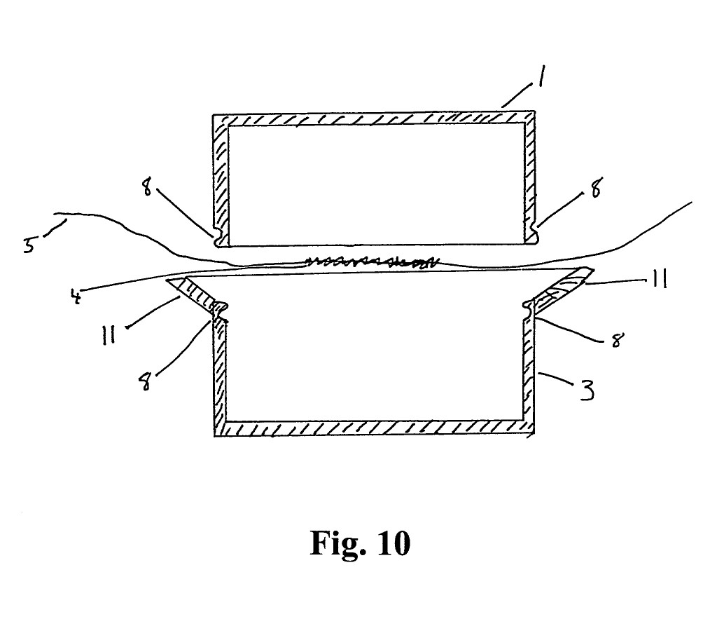

In another embodiment, the receptacle 3 is shaped to increase the fit between the source 1 and the receptacle 3 while the fabric is located between the two. In one embodiment, shown in FIG. 10, the receptacle 3 has an outwardly extending lip 11 into which the outer edge of the source 1 and the stained fabric fit.

The following specific examples will illustrate several embodiments of the present invention. It will be appreciated that other examples will be apparent to those of ordinary skill in the art and that the invention is not limited to these specific illustrative fluid sources, cleaning solutions or fluid receptacles.

### EXAMPLE 1

An injection molded, round fluid source (1 mm thick polyethylene) with 5 cm diameter is filled with 39 cc of 3% Triton X-100, the 1 mm opening is sealed with a cap.

A round fluid receptacle of dimensions of 5 cm diameter×3 cm thickness is made of dry, porous, hydrophilic polyurethane, and wrapped with water impermeable foil.

When used to clean a stain from a piece of fabric or cloth, the hydrophilic polyurethane receptacle is unwrapped and placed on one side of the stained article. Then the fluid source is opened and rubbed against the stain while the cleaning solution is pushed out of the source. The cleaning solution is thereby transferred from the source through the soiled article to the fluid receptacle by the “absorbing action” of the porous, hydrophilic polyurethane.

### EXAMPLE 2

An injection molded, round fluid source (1 mm thick polyethylene) with 5 cm diameter is filled with 5 cc of 3% Triton X-100. The opening of the fluid source is covered with a piece of cellulose filter paper and sealed with polyethylene film.

An injection molded round fluid receptacle of the similar dimensions and material of the fluid source is filled with 2 grams of dry cellulose powder, covered with a cellulose filter paper and sealed with water impermeable foil.

When used, the polyethylene film is peeled off the fluid source and the stained fabric is placed on top of the opening of the fluid source such that the stain to be removed is over the opening. The water impermeable foil on the fluid receptacle is then peeled off and the fluid receptacle is placed upside down on top of the area of fabric on top of the fluid source. The two containers are pressed against each other with the fabric to be cleaned between the two such that the rims of two containers are fitted tightly together. The two containers are then inverted as a unit so that the fluid source is on the top. The cleaning solution is transferred to the fluid receptacle, now beneath the fabric, by both gravitational force and the “soaking action” of the cellulose filter paper and dry cellulose powder.

### EXAMPLE 3

A square PET fluid source with 4 cm sides is filled with 10 cc of 0.2% liquid Tide and 0.01% calcium hypochlorite. The opening is sealed with a water impermeable polymer foil film.

A fluid receptacle of the same dimensions and material as the fluid source is filled with cotton gauze, covered with cellulose filter paper and sealed with water impermeable foil film.

When the device is used for cleaning, a sharp needle is used to punch holes in the foil film that covers the fluid source. The stained, colorfast fabric is placed on top of the foil side of the fluid source. The impermeable foil film is then peeled off the fluid receptacle and placed upside down on top of the source container with the stained fabric between the two. The four sides and corners of the receptacle are matched against those of the source. The two containers are pressed against each other tightly and inverted as a unit. While the fluid is transferred from the source to the receptacle, the stain is removed from the fabric.

### EXAMPLE 4

An injection molded, PVC fluid source with 5 cm diameter is filled with 10 cc of 1% Tween 20 and 1 ppm lipase. The opening of the fluid source is covered with a cellulose filter membrane, and sealed with a foil film.

An injection molded round fluid receptacle of the similar dimensions and material of fluid source is filled with 2 grams of dry cellulose power. The opening of the fluid source is covered with a cellulose filter paper and sealed with water impermeable foil film.

When used, the foil film is peeled off the fluid source and the stained fabric is placed on top of the opening of the fluid source such that the stain to be removed is over the opening. The water impermeable foil on the fluid receptacle is then peeled off and the fluid receptacle is placedupside down on top of the area of fabric on top of the fluid source. The two containers are pressed against each other with the fabric to be cleaned between the two such that the rims of two containers are fitted tightly together. The two containers arethen inverted as a unit so that the fluid source is on the top. The cleaning solution is transferred to the fluid receptacle, now beneath the fabric, by both gravitational force and the “soaking action” of the cellulose filter paper and dry cellulose powder.

### EXAMPLE 5

An injection molded, polyethylene fluid source with 5 cm diameter is filled with 10 cc of acetone, covered with a cellulose filter membrane, and heat sealed with a polyethylene foil film.

An injection molded round fluid receptacle of similar dimensions and material as the fluid source is packed with cotton gauze, covered with a cellulose filter paper and sealed with similar foil film.

When the device is used for cleaning, the polyethylene foil film is peeled off the fluid source and the stained fabric is placed on top of the opening of the fluid source such that the stain to be removed is over the opening. The foil film on the fluid receptacle is then peeled off and the fluid receptacle is placed upside down on top of the area of fabric on top of the fluid source. The two containers are pressed against each other with the fabric to be cleaned between the two such that the rims of two containers are fitted tightly together. The two containers are then inverted as a unit so that the fluidsource is on the top. The cleaning solution is transferred to the fluid receptacle, now beneath the fabric, by both gravitational force and the “soaking action” of the cellulose filter paper and dry cellulose powder.

### EXAMPLE 6

A fluid source is made by minimally gluing a piece of 2″×2″×¼″ cotton gauze on a 3″×3″ foil film. The semi-assembled source is then briefly soaked in a 5% BZK (benzalkonium chloride) solution. Excess amount of fluid is shaken loose. Then it is sealed with another piece of a 3″×3″ foil film to form a sealed pouch.

A fluid receptacle is made by minimally gluing a piece of 2″×2″×¼″ cotton gauze on a 3″×3″ foil film. Then it is sealed with another piece of a 3″×3″ foil film to form a sealed pouch.

When used, the fluid receptacle pouch is opened and the cotton gauze therein is pressed against the stain. Then, the fluid source pouch is opened and the BZK soaked cotton gauze is pressed against the stain on the opposite side of the fabric from the cotton gauze of the fluid receptacle. As the BZK solution is pulled through the fabric, the stain is removed.

### EXAMPLE 7

An injection molded, polypropylene fluid source 10 cm in diameter is filled with 50 cc of 0.4% surfactin and sealed with a foil film.

An injection molded round fluid receptacle of the similar dimensions and polypropylene as of fluid source is packed with cotton gauze, covered with a cellulose filter paper and sealed with similar foil film.

When used, the foil film is peeled off the fluid source and the stained fabric is placed on top of the opening of the fluid source such that the stain to be removed is over the opening. The foil film on the fluid receptacle is then peeled off and the fluid receptacle is placed upside down on top of the area of fabric on top of the fluid source. The two containers are pressed against each other with the fabric to be cleaned between the two such that the rims of two containers are fitted tightly together. The two containers are then inverted as a unit so that the fluid source is on the top. The surfactin solution is transferred to the fluid receptacle, now beneath the fabric, by both gravitational force and the “soaking action” of the cellulose filter paper and dry cellulose powder.

### EXAMPLE 8

A square polyethylene fluid source with 4 cm sides is filled with 10 cc of 0.2% liquid Tide and 0.1 microgram of proteases, and sealed with a water impermeable polymer foil film.

A fluid receptacle of the same dimensions and material of fluid source is filled with dry cellulose powder, covered with a cellulose filter paper and sealed with a water impermeable foil film.

When the device is used for cleaning, a sharp needle is used to punch holes in the foil film that covers the fluid source. The stained, colorfast fabric is placed on top of the foil side of the fluid source. The impermeable foil film is then peeled off the fluid receptacle and placed upside down on top of the source container with the stained fabric between the two. The four sides and corners of the receptacle are matched against those of the source. The two containers are pressed against each other tightly and inverted as a unit. While the fluid is transferred from the source to the receptacle, the stain is removed from the fabric.

It should be understood, of course, that the foregoing relates only to preferred embodiments of the present invention and that numerous modifications or alterations may be made therein without departing from the spirit and the scope of the invention as set forth in the appended claims.

What is claimed is:

1. A method of treating soiled fabric, comprising
a) inserting fabric into a device containing a cleaning solution; and
b) allowing the cleaning solution to move across the fabric.

2. The method of claim 1 wherein the cleaning solution comprises at least one from the group comprising organic solvents, surfactants, detergents, enzymes, bleaches, fabric brighteners, blends and combinations.

3. The method of claim 1, further comprising treating the fabric with the piercing element.

4. The method of claim 2 wherein the surfactant is selected from anionic surfactants, cationic surfactants, non-ionic surfactants, blends, and combinations.

5. The method of claim 2 wherein the surfactant is selected from synthetic surfactants, natural surfactants, combinations, and blends.

6. The method of claim 4 wherein the enzymes is selected from amylases, proteinases, aminopeptidases, carboxypeptidases, lipases, DNAses, RNAses, blends and combinations.

7. The method of claim 2 wherein the bleach is selected from chlorinated compounds, peroxides, reducing agents, color brighteners, blends and combinations.

8. A device for treating soiled fabric, comprising
a) at least one chamber;
b) wherein at least one chamber is capable of containing a cleaning solution; and
c) wherein at least one chamber has a surface for receiving fabric.

9. The device of claim 8 wherein the at least one chamber is made of metallic materials, synthetic materials, natural materials, blends and combinations.

10. The device of claim 8 wherein the cleaning solution comprises at least one from the group comprising organic solvents, surfactants, detergents, enzymes, bleaches, fabric brighteners, blends and combinations.

11. The device of claim 10 wherein the solvent is selected from alcohols, acetone, ether, benzene, toluene, THF, petroleum spirit, blends and combinations.

12. The device of claim 10 wherein the surfactant is selected from anionic surfactants, cationic surfactants, non-ionic surfactants, blends, and combinations.

13. The device of claim 10 wherein the surfactant is selected from synthetic surfactants, natural surfactants, combinations, and blends.

14. The device of claim 10 wherein the enzyme is selected from amylases, proteinases, aminopeptidases, carboxypeptidases, lipases, Dnases, Rnases, blends and combinations.

15. The device of claim 10 wherein the bleach is selected from chlorinated coupounds, perioxides, reducing agents, color brighteners, blends and combinations.

16. The device of claim 8 wherein a flat outlet of at least one chamber has a minimum area of 0.03 cm².

17. A device for treating soiled fabric, comprising
a) a chamber containing a cleaning solution; and
b) an absorbent-containing absorbing material.

18. The device of claim 17 wherein the chamber is made of metallic materials, synthetic materials, natural materials, blends and combinations.

19. The device of claim 17 wherein the absorbent material is made of metallic materials, synthetic materials, natural materials, blends and combinations.

20. The device of claim 17, wherein the cleaning solution comprises at least one from the group comprising organic solvents, surfactants, detergents, enzymes, bleaches, fabric brighteners, blends and combinations.
